(19) United States
(12) Patent Application Publication
(10) Pub. No.: US 2026/0162234 A1
(43) Pub. Date: Jun. 11, 2026

(54) TRAINING-FREE TECHNIQUES FOR RESOLVING COLOR INCONSISTENCY IN DIFFUSION MODEL INPAINTING

(71) Applicant: Microsoft Technology Licensing, LLC, Redmond, WA (US)

(72) Inventors: Ji LI, San Jose, CA (US); Mingxi CHENG, San Jose, CA (US); Yuhui YUAN, Beijing (CN); Zhixuan LIU, Pittsburgh, PA (US)

(21) Appl. No.: 18/972,810

(22) Filed: Dec. 6, 2024

(51) Int. Cl. G06T 5/77; G06T 3/40; G06T 5/70; G06T 7/12

(52) U.S. Cl. CPC G06T 5/77; G06T 3/40; G06T 5/70; G06T 7/12; G06T 2207/20182

(57) ABSTRACT

A staged approach for mitigating color inconsistencies arising from Diff-Edit based inpainting may include blended masked-maskless inpainting, dynamic mask modification, and/or mask boundary latent value smoothing. Blended masked-maskless inpainting mitigates color inconsistencies by blending masked inpainting with maskless inpainting during iterative denoising steps. Dynamic mask modification serves to iteratively modify the mask in the spatial dimension during iterative denoising steps. Mask boundary latent value smoothing may be applied to smooth latent values at the edge of the masked region.

### BACKGROUND

Design artifacts (e.g., banners, invitations, etc.) in graphics design software application often allow users to insert their own text in a region often referred to as a masked region. For example, a template birthday card may include a masked region that allows the user to insert the name of the recipient (e.g., “Happy Birthday John”) so that the template may be adequately customized based on the user's preference. Inpainting may then be performed in areas of the masked region that are not covered by the text, so that the background of the masked region matches the background of the unmasked region. One challenge with masked inpainting is that it can be difficult to sufficiently match the color, pattern, or texture of the inpainted region with that of the unmasked region. This may result in a visual inconsistency that detracts from the aesthetic design of the artifact. Techniques for improving the effectiveness of inpainting are therefore desired.

### SUMMARY

Some examples provide a method for blended masked-maskless inpainting. In this example, the method includes receiving a request to edit a text object of an image artifact and applying, to the image artifact, a mask for editing the text object of the image artifact. The mask delineates a border between a masked region of the image artifact and an unmasked region of the image artifact. The method further includes introducing, into the image artifact, noise spanning the masked region and at least a portion of the unmasked region, and performing iterative inpainting on the image artifact over a sequence of time-domain instances to obtain a denoised image artifact that includes an edited text object. Performing iterative inpainting on the image artifact includes performing masked inpainting on the image artifact during an initial time-domain instance and performing maskless inpainting to at least partially remove residual noise from the image artifact during a subsequent time-domain instance. The mask is removed from the image artifact in-between the initial time-domain instance and the subsequent time-domain instance. The method further includes outputting the denoised image artifact in response to the request to edit the text object of the image artifact.

Other examples provide a method for dynamic mask modification. In such examples, the method includes receiving a request to edit a text object of an image artifact and applying, to the image artifact, an original mask for editing the text object of the image artifact. The original mask delineates an original border between a masked region of the image artifact and an unmasked region of the image artifact. The method further includes introducing, into the image artifact, noise spanning the masked region and at least a portion of the unmasked region and performing iterative inpainting on the image artifact over a sequence of time-domain instances to obtain a denoised image artifact that includes an edited text object. Performing iterative inpainting on the image artifact includes performing masked inpainting on the image artifact during an initial time-domain instance using the original mask, modifying the original mask after the initial time-domain instance, and performing masked inpainting on the image artifact during a subsequent time-domain instance using the modified mask. The method further includes outputting the denoised image artifact in response to the request to edit the text object of the image artifact.

Other examples provide a method for mask boundary latent value smoothing. In such examples, the method includes receiving a request to edit a text object of an image artifact and applying, to the image artifact, a mask for editing the text object of the image artifact. The mask delineates a border between a masked region of the image artifact and an unmasked region of the image artifact. The method further includes introducing, into the image artifact, noise spanning the masked region and at least a portion of the unmasked region and performing iterative inpainting on the image artifact to obtain a denoised image artifact that includes an edited text object. Performing iterative inpainting on the image artifact includes performing masked inpainting on the image using the mask and averaging neighboring masked and unmasked latent values along the border delineated by the mask. The method further includes outputting the denoised image artifact in response to the request to edit the text object of the image artifact.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagram illustrating a DIFFEDIT technique for editing non-text elements in a picture image;

FIG. 2 is a diagram illustrating a DIFFEDIT technique for editing text objects in an invitation;

FIG. 3 is a diagram of a traditional masked inpainting technique for modifying a text object in a masked image;

FIG. 4 is a diagram of an iterative denoising process used during traditional masked inpainting to insert text into, and remove noise from, an image artifact;

FIG. 5 is a diagram of an iterative denoising process used during blended masked-maskless inpainting to insert text into, and remove noise from, an image artifact;

FIG. 6 is a diagram of an iterative denoising process used during blended masked-maskless inpainting;

FIG. 7 is a flowchart of a method for blended masked-maskless inpainting;

FIG. 8 is a diagram of an iterative denoising process used for dynamic mask modification during masked inpainting;

FIG. 9 is a diagram of an iterative denoising process for dynamic mask modification during blended masked-maskless inpainting;

FIG. 10 is a flowchart of a method for dynamic mask modification;

FIG. 11 is a diagram of mask boundary latent value smoothing used during masked inpainting;

FIG. 12 is a diagram of mask boundary latent value smoothing used in conjunction with dynamic mask modification during masked inpainting;

FIG. 13 is a flowchart of a method for mask boundary latent value smoothing;

FIG. 14 is a functional block diagram of a computing apparatus.

Corresponding reference characters indicate corresponding parts throughout the drawings. Any of the figures may be combined into a single example or embodiment.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum. Aspects of this disclosure may relate to U.S. patent application Ser. No. 18/536,644 entitled “THEMATIC VARIATION GENERATION FOR AI-ASSISTED GRAPHIC DESIGN” filed on Dec. 12, 2023 and U.S. patent application Ser. No. 18/890,055 entitled “CUSTOM COMPLEX DOCUMENT DESIGN VIA ARTIFICIAL INTELLIGENCE INTEGRATION” filed on Sep. 19, 2024, both of which are incorporated by reference herein as if reproduced in their entities.

Design artifacts in graphics design software application may use an inpainting pipeline such as Stable Diffusion XL (SDXL). The design artifacts are generally based on blueprints manually crafted by expert designers and then processed through masked or maskless inpainting, or image-to-image pipelines, to generate design variations. This approach offers great flexibility, consistently producing visually appealing designs. Artifacts that rely on the SDXL inpainting pipeline (hereinafter, the “SDXL”) may inherit limitations in masked inpainting that result in inconsistencies, such as color irregularity, in the inpainted portion of the masked region. These inconsistencies may be more pronounced when the inpainted area involves a solid color. To mitigate these inconsistencies, the blueprints may be designed with large blank or solid-colored areas to accommodate text overlays in order to create a balanced design that combines both the image and text. However, the blank or solid-colored areas may amplify the inpainting inconsistencies (e.g., color irregularities) in the masked region.” For example, inpainting that is in close proximity to the text (e.g., inpainting representing the text background) may exhibit more pronounced color inconsistencies than inpainting proximate to the edge of the masked region.

Aspects of this disclosure address this issue by using latent value filling to resolve color inconsistencies within the SDXL. A standard SDXL may utilize diffusion-based semantic image editing with mask guidance (referred to as “Diff-Edit” to first introduce noise into the input image and then perform denoising to remove the noise based on the query text. Denoising may introduce initial latent values into the noised input image. The magnitude of the initial latent values may be set below the maximum magnitude value of one such that the unmasked areas are influenced by both the original image latent values and the text guidance. This may ensure that the original image features, such as layout or texture, are not completely removed during inpainting. Because the masked area is not influenced by the text query, the masked area is not changed by virtue of introducing noise into the input image and removing noise from the input image. In an ideal noising/denoising process, the masked area would remain unchanged. In this sense, the masked and unmasked regions are influenced differently by inpainting which produces a distinct visual color inconsistency in the masked region.

Aspects of this disclosure provide a staged approach for mitigating color inconsistencies arising from Diff-Edit based inpainting pipelines using various techniques, including “blended masked-maskless inpainting,” “dynamic mask modification,” and “mask boundary latent value smoothing.”

Blended masked-maskless inpainting mitigates color inconsistencies by blending masked inpainting with maskless inpainting during iterative denoising steps. During inpainting, noise is iteratively removed over a series of time domain instances (e.g., t=0, t=1, . . . t=max). For example, inpainting removes noise from the original image during a first time-domain instance (e.g., t=1) to produce a new version of the image (e.g., image_1) that has less noise than image_0. This process is repeated during each of the remaining time domain-instances (e.g., t=2, t=3, . . . t=max) to produce a new version of the image (e.g., image_2, image_3, . . . image_max) having less noise than the previous version of the image (e.g., image_2 having less noise than image_1, image_3 having less noise than image_2, etc.) until the final version of the image is output (e.g., image_max).

Traditional masked inpainting techniques employ a “mask” during iterative denoising, which results in the rigid boundary addition of neighboring masked and unmasked latent values, causing a sudden change in latent values around the mask boundary. In contrast, maskless inpainting does not employ a “mask” and therefore rigid boundary addition is avoided.

Embodiment blended masked-maskless inpainting techniques provided herein perform masked inpainting during some time-domain instances and maskless inpainting during other time-instances. This serves to mitigate color inconsistencies that would otherwise result during traditional masked inpainting (e.g., where masked inpainting is performed during every time-domain instance). To illustrate this concept, consider an example blended masked-maskless inpainting technique that performs masked inpainting during odd time-domain instances (e.g., t=1, t=3, etc.) and maskless inpainting during even time-domain instances (e.g., t=2, t=4, etc.). In this example, image_1 and image_3 are produced with masked inpainting (which employs a “mask” during denoising), while image_2 and image_4 are produced with maskless inpainting (which performs denoising without a “mask”). As such, color inconsistencies are introduced into image_1 and image_3, but not into image_2 and image_4, thereby reducing aggregate color inconsistency that would have otherwise been resulted from traditional masked inpainting (which employs a “mask” when denoising during every time-domain instance). It should be appreciated that this is only one example of blended masked-maskless inpainting, and that other examples may utilize different allocations of masked and maskless inpainting to time-domain instances. For instance, masked inpainting may be performed in a 2:1 ratio relative to maskless inpainting such that masked inpainting is performed during time-domain instances t=1, t=2, t=4, t=5, t=7, t=8, etc. and maskless inpainting is performed during time-domain instances t=3, t=6, etc. In some examples, blended masked-maskless inpainting may employ a “hyperparameter” (e.g., “blend_end”) to control how many time-domain steps are allocated to masked inpainting versus maskless inpainting. As an example, the hyperparameter may be set to a higher value to increase the ratio or number of masked inpainting iterations relative to maskless inpainting iterations, or a lower value to decrease the ratio or number of masked inpainting iterations relative to maskless inpainting iterations.

Dynamic mask modification serves to iteratively modify the mask in the spatial dimension during iterative denoising steps. More specifically, dynamic mask modification may gradually reduce the size of the mask during masked inpainting steps such that the mask boundary shrinks as denoising is performed over successive time-domain instances. In one example, the mask may be assigned a maximum mask size (e.g., mask_max) for the first time-domain instance (e.g., t=1) and a minimum mask size (e.g., mask_min) for the last time-domain instance (e.g., t=max), with the mask's size being iteratively reduced from mask_max to mask_min during intermediate masked inpainting steps (e.g., t=2, t=3, . . . t=max−1.). It should be appreciated that dynamic mask modification may be combined with blended masked-maskless inpainting, in which case the mask's size may be modified between successive masked inpainting steps. For example, in the above discussed example of blended masked-maskless inpainting where masked inpainting is performed during odd time instances (t=1, t=3, t=5, etc.) and maskless inpainting is performed during even time instances (t=2, t=4, t=5, etc.), the mask may be reduced during odd time-instances (e.g., mask_max during t=1, mask_mid for t=3, t=5, etc., and mask_min for t=max), but otherwise absent during even time instances (e.g., no mask during t=2, t=4, etc.) when maskless inpainting is performed. It should further be appreciated that dynamic mask modification is not limited to iteratively reducing the mask's size during iterative denoising, and may instead increase the mask's size, or otherwise modify the mask's shape, during iterative denoising, and that dynamic mask modification may dynamically change the mask's size or shape in a linear or non-linear fashion.

Dynamic mask modification may mitigate color inconsistency by reducing the number or frequency of abrupt changes to latent values at the mask boundary, and by extension reduce pixel inconsistency after decoding. In this way, dynamic mask modification may smooth latent value transitions around the mask by shrinking (or otherwise modifying) the mask as iterative denoising is performed over the time-domain instances, thereby causing the boundary areas to be denoised over multiple time steps (which reduces the degree in which latent values are changed during a given denoising iteration).

Mask boundary latent value smoothing may be applied to smooth latent values at the edge of the masked region. This may be done by averaging each latent value at the edge of the masked region with its K nearest neighbors. This serves to smooth the gradient of latent values extending inward from the edge of the masked region towards the center of the masked region. In some examples, mask boundary latent value smoothing is combined with dynamic mask modification such that smoothing is performed each time the mask's is reduced. This results in an iterative smoothing of the masked region (or masked boundary).

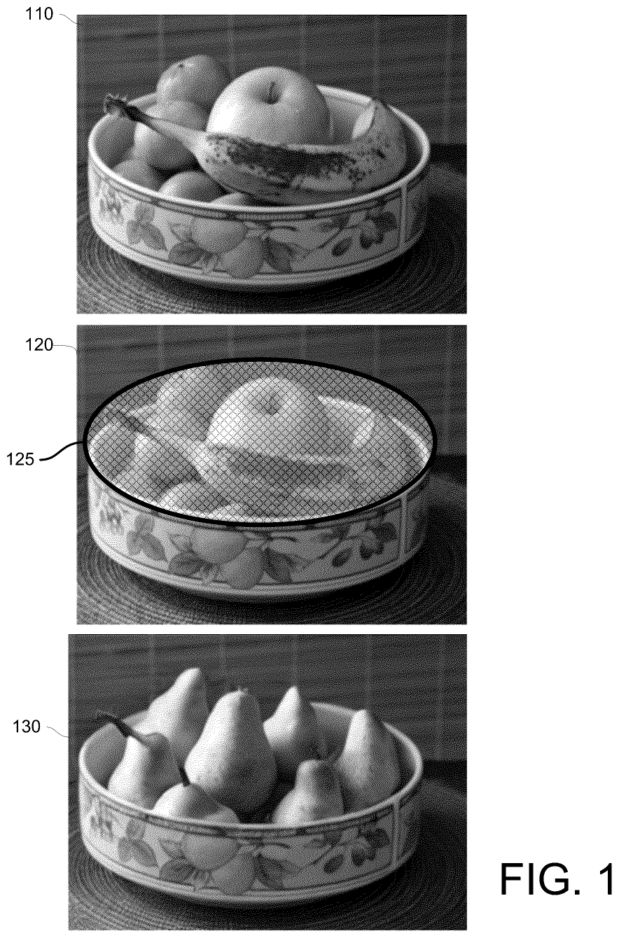

Blended masked-maskless inpainting, dynamic mask modification, and/or mask boundary latent value smoothing may be employed to correct color inconsistencies resulting from the use of diffusion edit (DIFFEDIT) techniques to modify text in an image artifact. The term “image artifact” is used broadly to refer to any image, or portion of an image, that is received, processed, or output during iterative inpainting, such as an input image, a masked image, a noised image (e.g., Image_0, Image_1, . . . Image_max), and a denoised image. DIFFEDIT techniques were first proposed by non-patent literature (NPL) publication entitled “Diffedit: Diffusion-based semantic image editing with mask guidance,” which is incorporated by reference herein as if reproduced in its entirety. That publication proposed using DIFFEDIT techniques to edit non-text elements of a picture image. FIG. 1 is a diagram illustrating a DIFFEDIT technique for editing non-text elements in a picture image 110. As shown, the picture image 110 depicts a bowl of mixed fruit and the DIFFEDIT technique is used to edit the “mixed fruit” element of the picture image 110 to obtain a picture image 130 depicting a bowl of “pears.” To achieve this, the DIFFEDIT technique generates a mask 125 overlaying the “mixed fruit” element to obtain the masked image 120. The terms “mask” and “masked region” are used interchangeably herein. The masked image 120 is then modified through a process called masked inpainting, which adds noise to the image region 125 and then de-noises the region to replace the noise with pixel values representing the modified non-text element (e.g., the bowl of pears). This works well when editing non-text versions of a picture image for the reasons discussed in the above referenced NPL publication.

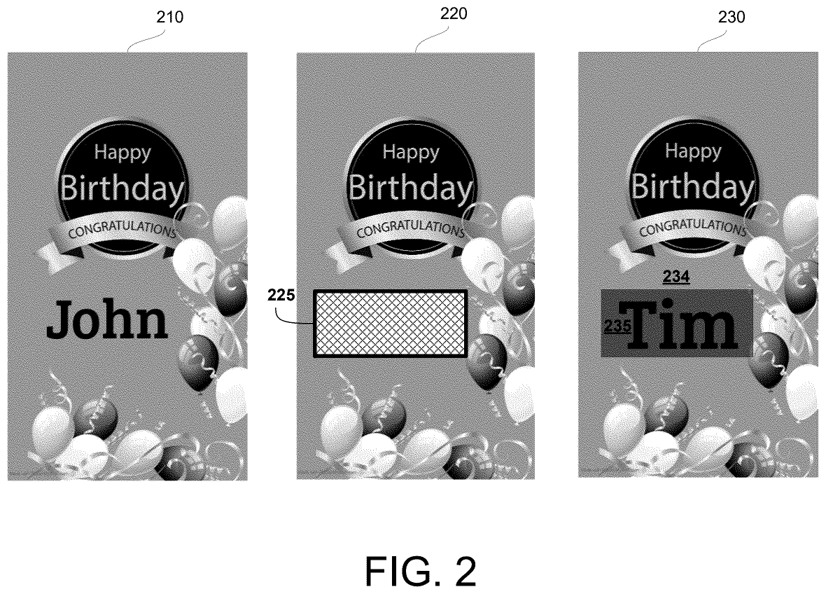

DIFFEDIT diffusion models may also be used to edit text in a design artifact such as a banner or invitation. FIG. 2 is a diagram illustrating a DIFFEDIT technique for editing text objects in an invitation; In this example, the DIFFEDIT technique edits an invitation 210 specifying “John” to obtain an invitation 230 specifying “Tim”. As shown, the DIFFEDIT technique generates a mask 225 overlaying the region of the invitation 210 that includes the text “John,” thereby resulting in the masked image 220. The masked image 220 is then modified using masked inpainting to insert the text “Tim” resulting in the invitation 230. However, unlike editing non-text elements of a picture image, masked inpainting tends to produce color inconsistencies in the masked region when editing text elements of a image artifact. This arises because the background of the design artifact is often contiguous between the unmasked and masked regions. As such, denoising the masked region often results in rigid boundary addition between masked latent values and unmasked latent values, which in-turn causes a sudden change in latents around the mask boundary, resulting in color inconsistencies following encoding. This can be seen in the invitation 230 which includes a color differential between the masked region 235 and the unmasked region 234.

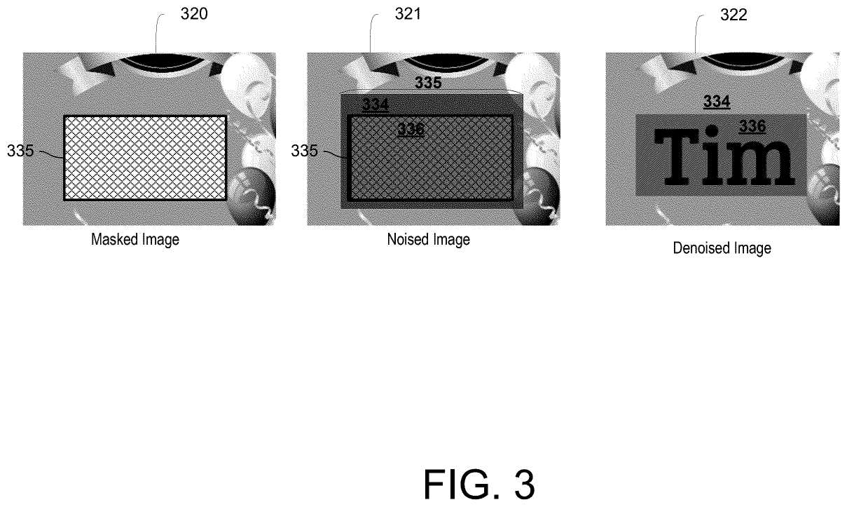

FIG. 3 is a diagram of a traditional masked inpainting technique for modifying a text object in a masked image. As shown, the traditional masked inpainting technique is used to modify text in a masked image 320, which corresponds to the masked image 220 depicted in FIG. 2. Noise 335 is added to the masked image 320 to produce the noised image 321. Denoising is then performed on the noised image 321 to iteratively remove the noise 335, as well as to insert latent values depicting the text “Tim” in the masked region 336. This produces the denoised image 322 which includes color inconsistencies between the unmasked region 334 and masked region 336.

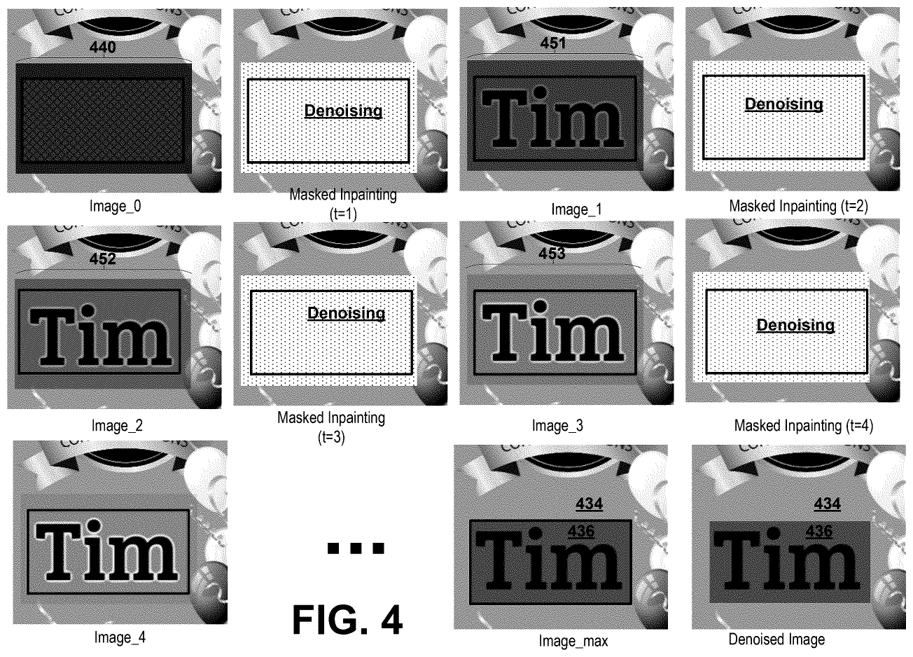

FIG. 4 is a diagram of an iterative denoising process used during traditional masked inpainting to insert text into, and remove noise from, an image artifact. In this example, iterative denoising is used during traditional masked inpainting to insert text into, and remove noise from, a noised image (image_0) in order to generate a denoised image. Image_0 and the denoised image as depicted in FIG. 4 correspond to the noised image 321 and the denoised image 322 (respectively) as depicted in FIG. 3. As shown, the noised image corresponds to image_0 of the iterative denoising sequence. During the first time-domain instance (t=1), masked inpainting is performed on the image_0 to both remove a portion of the noise 440, as well as to insert latent values that represent the text “Tim,” thereby resulting in image_1 that includes residual noise 441 as well as latent values that represent “Tim.” It should be appreciated that the latent values representing “Tim” may be added gradually over the course of the iterative denoising process, and that the latent values depicted in image_0 may appear to more “complete” than they might otherwise be in practice.

During the next time-domain instance (t=2), masked inpainting is performed on image_1 to remove a portion of the residual noise 451, as well as to insert additional latent values to continue forming “Tim” within the mased region. This results in image_2 that includes residual noise 452 and slightly more of the latent values representing “Tim.” During the next time-domain instance (t=3), masked inpainting is performed on image_2 to remove a portion of the residual noise 452 and to continue forming “Tim” within the mased region, resulting in image_3 that includes residual noise 453 and slightly more of the latent values representing “Tim. Masked inpainting is repeated until the last time-domain instance (t=max), where the final iterative denoising step generates image_max, which is largely devoid of noise but includes color inconsistencies between the masked region 436 and the unmasked region 434. It should be appreciated that the color inconsistency does not represent noise, but rather represents how denoising affects latent values in the masked region 436 differently than latent values in the unmasked region 436. More specifically, denoising causes unmasked latent values to be combined with masked latent values, which results in rigid boundary addition that causes a non-uniform spike in latent values in the vicinity of the masked boundary.

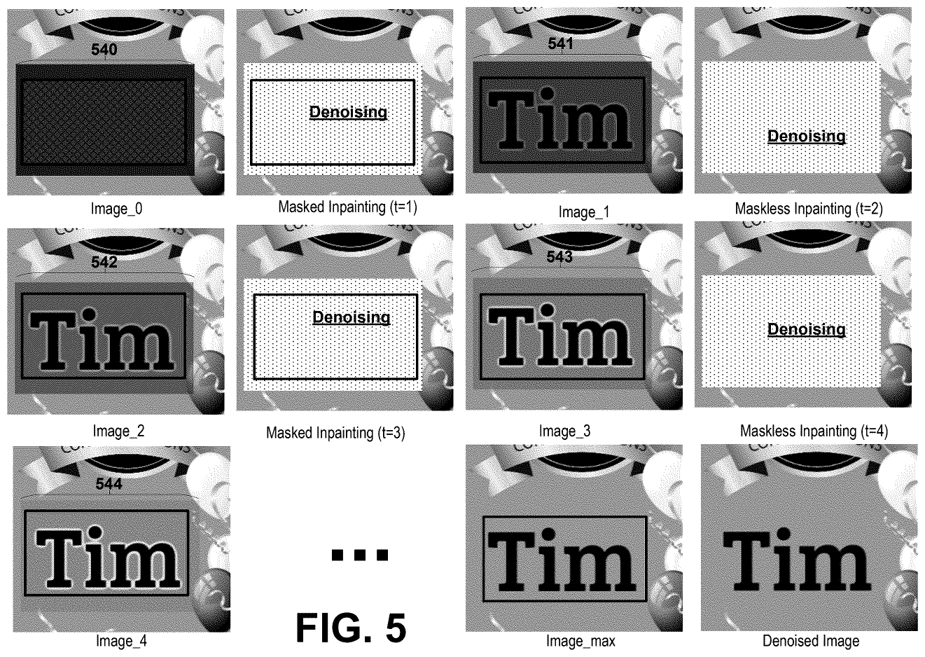

Embodiments of this disclosure provide blended masked-maskless inpainting techniques to mitigate color inconsistencies that would have otherwise resulted from traditional masked inpainting. Turning now to FIG. 5, which provides a diagram illustrating an iterative denoising process used during blended masked-maskless inpainting to insert text into, and remove noise from, an image artifact. In this example, the iterative denoising process is used to insert text into, and remove noise from, a noised image (image_0) in order to generate a denoised image. During the first time-domain instance (t=1), masked inpainting is performed on the image_0 to both remove a portion of the noise 540, as well as to insert latent values that represent the text “Tim,” thereby resulting in image_1 that includes residual noise 541 as well as latent values that represent “Tim.” As mentioned above, it should be appreciated that the latent values representing “Tim” may be added gradually over the course of the iterative denoising process, and that the latent values depicted in image_0 may appear to more “complete” than they might otherwise be in practice.

During the next time-domain instance (t=2), maskless inpainting is performed on image_1 to remove a portion of the residual noise 541 without adding latent values to further represent “Tim.” This results in image_2 that includes residual noise 542 (which is slightly less than residual noise 541) and reflects roughly the same latent value representation of “Tim” as image_1. During the next time-domain instance (t=3), masked inpainting is performed on image_2 to remove a portion of the residual noise 542 and to continue forming “Tim” within the masked region, thereby resulting in image_3 that includes residual noise 543 (which is slightly less than residual noise 542) as well as latent values that more fully represent “Tim” than image_2. During the next time-domain instance (t=4), maskless inpainting is performed on image_3 to remove a portion of the residual noise 543, thereby resulting in image_4 that includes residual noise 544 (which is slightly less than residual noise 543). The process alternates between masked and maskless inpainting until denoising has been performed during the last time-domain instance (t=max) to generate image_max, which is largely devoid of noise. Notably, blended masked-maskless inpainting is effective to mitigate much of the rigid boundary addition that would have otherwise occurred during traditional masked inpainting, and as a result the masked and unmasked regions in the image_max (as well as the denoised image) are largely devoid color inconsistencies.

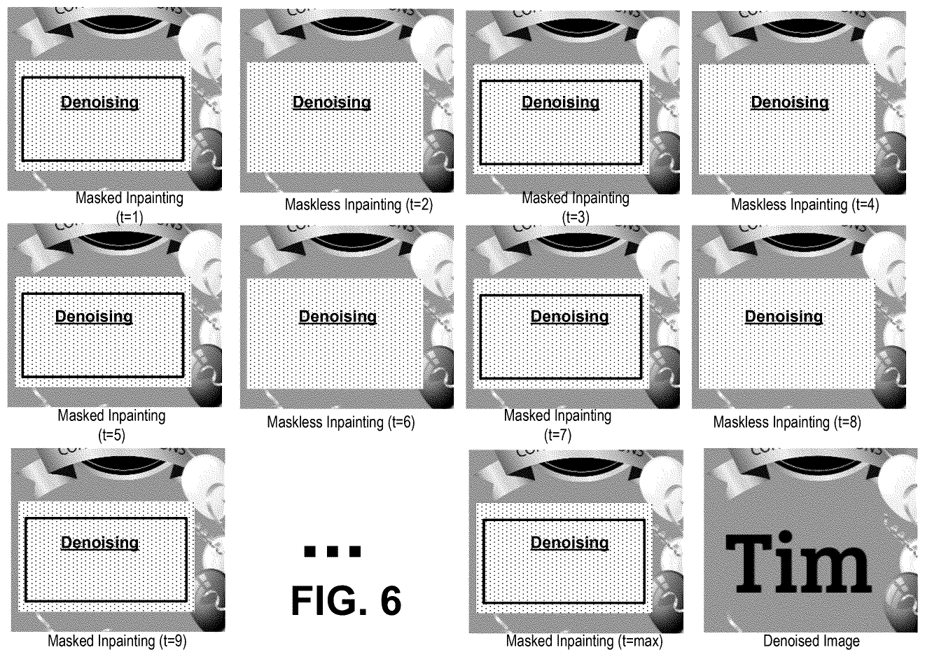

FIG. 6 is a diagram of an iterative denoising process used during blended masked-maskless inpainting. In FIG. 6, denoised images are not shown so as to allow additional denoising iterations to be depicted for the purpose of explaining how blended masked-maskless inpainting may be performed over an extended number of time-domain instances. As shown, masked inpainting is performed during odd time-domain instances (t=1, t=3, t=5, t=7, t=9), while maskless inpainting is performed during even time-domain instances (t=2, t=4, t=6, t=8). The process alternates between masked and maskless inpainting until the iteration of denoising is performed to generate a denoised image.

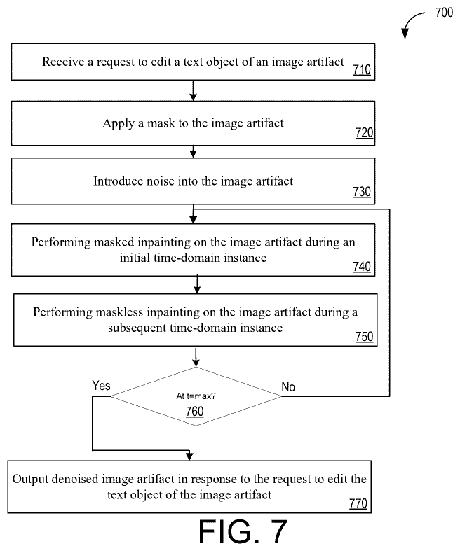

FIG. 7 is a flowchart of a method 700 for blended masked-maskless inpainting. At step 710, the method includes receiving a request to edit a text object of an image artifact. At step 720, a mask is applied to the image artifact for editing the text object of the image artifact. The mask delineates a border between a masked region of the image artifact and an unmasked region of the image artifact. At step 730, noise is introduced into the image artifact such that the noise spans the masked region and at least a portion of the unmasked region. At step 740, masked inpainting is performed on the image artifact during an initial time-domain instance to partially remove the noise from the image artifact. At step 750, maskless inpainting is performed on the image artifact during a subsequent time-domain instance to at least partially remove residual noise from the image artifact. The mask is removed from the image artifact in-between the initial time-domain instance and the subsequent time-domain instance. The method 700 then proceeds to step 760, where it is determined whether the current time-domain instance is t=max. If so, then iterative inpainting is complete and the method 700 proceeds to step 770. Otherwise, the method 700 reverts back to step 740. At step 770, a denoised image artifact that includes an edited text object is output in response to the request to edit the text object of the image artifact. Masked inpainting may introduce latent values, into the masked region for forming the edited text object. Maskless inpainting at least partially removes the residual noise from the image artifact without impacting the latent values forming the image artifact. Masked inpainting may be performed during a first subset of the time-domain instances and maskless inpainting may be performed during a second subset of the time-domain instances. The first subset of time-domain instances may be interleaved with the second subset of time-domain instances such that the masked inpainting and the maskless inpainting are performed in an alternating fashion. Alternatively, the first subset of time-domain instances may include more time-domain instances than the second subset of time-domain instances such that the masked inpainting is performed more often than the maskless inpainting, e.g., twice as often, etc. Alternatively, the second subset of time-domain instances may include more time-domain instances than the first subset of time-domain instances such that the maskless inpainting is performed more often than the masked inpainting, e.g., twice as often, etc. In one example, the first and/or subsets of time-domain instances may be allocated to masked and/or maskless inpainting based on a hyperparameter that defines a ratio or number of masked inpainting iterations relative to maskless inpainting iterations.

Embodiments of this disclosure provide dynamic mask modification techniques to further mitigate color inconsistencies resulting from masked inpainting. It should be appreciated that dynamic mask modification may be performed independently, or in conjunction with, blended masked-maskless inpainting.

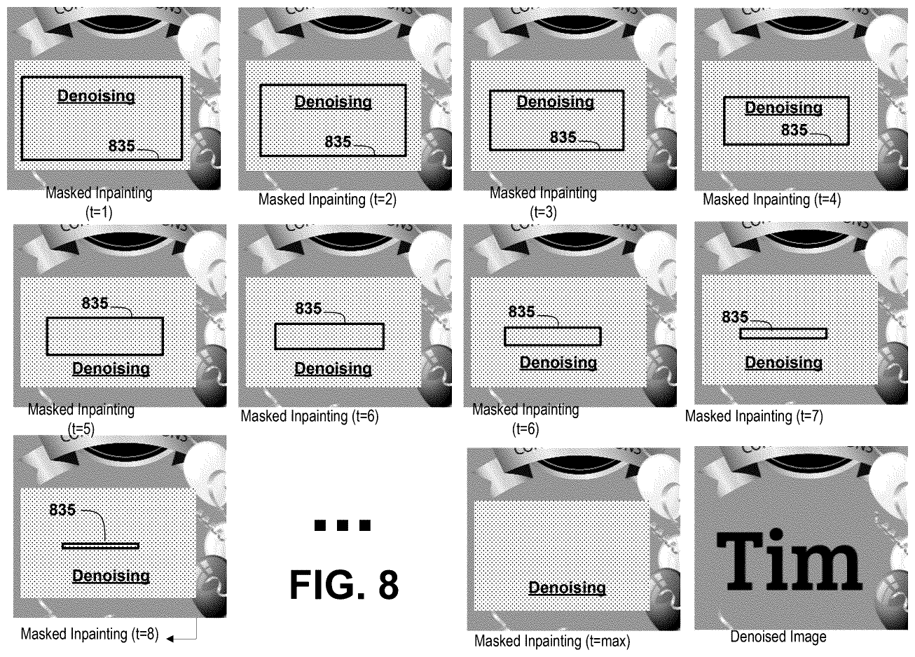

FIG. 8 is a diagram of an iterative denoising process used for dynamic mask modification during masked inpainting. As shown, masked inpainting is performed during each time-domain instance in order to both remove noise from a noised image (image_0, as well as to introduce latent values representing “Tim” into the resulting denoised image. During the first time-domain instance (t=1), masked inpainting is performed on the image_0 using the mask 835. During the next time-domain instance (t=2), a size of the mask 835 is reduced and additional denoising is performed. The process of reducing the size of the mask 835 and performing iterative masked inpainting is repeated until the last time-domain instance (t=max), at which point a denoised image is generated. The denoised image is largely devoid of noise and includes latent values representing “Tim.” Notably, dynamic mask modification serves to iteratively change the location in which masked and unmasked latent values are combined, which reduces the severity of rigid boundary addition during the denoising process. As a result, the masked and unmasked regions in the image_max (as well as the denoised image) are largely devoid color inconsistencies.

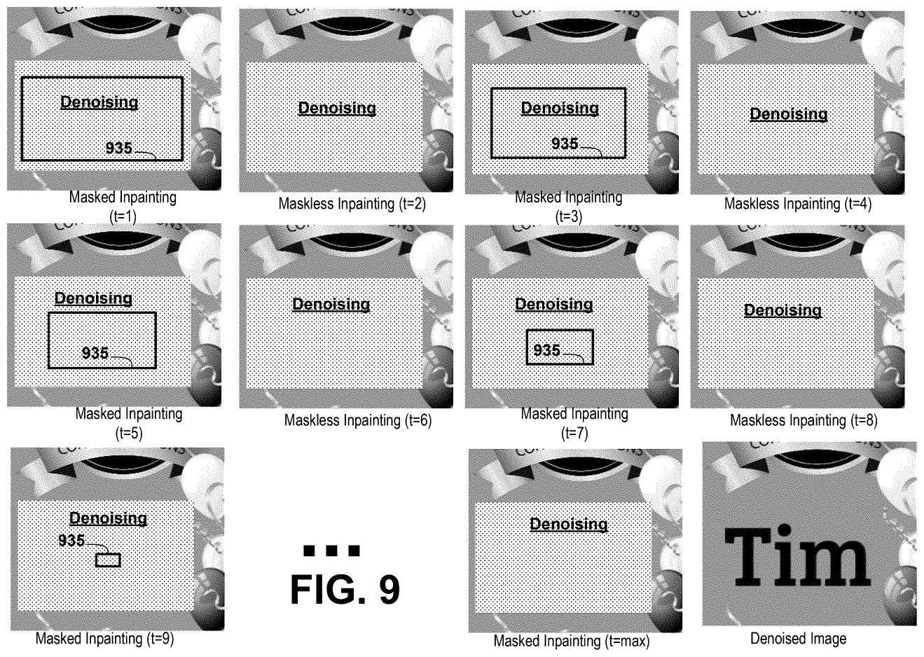

In some examples, dynamic mask modification is performed in conjunction with blended masked-maskless inpainting to further mitigate color inconsistencies resulting from masked inpainting. FIG. 9 is a diagram of an iterative denoising process for dynamic mask modification during blended masked-maskless inpainting. As shown, masked inpainting is performed during odd time-domain instances (t=1, t=3, t=5, t=7, t=9), while maskless inpainting is performed during even time-domain instances (t=2, t=4, t=6, t=8). The size of the mask 935 is reduced during each iteration of masked inpainting (e.g., from t=1 to t=3, from t=3 to t=5, t=5 to t=7, t=7 to t=9). The process of alternating between masked and maskless inpainting is continued until the last iteration of denoising is performed (at t=max) to generate a denoised image. Likewise, the process of dynamic mask reduction is performed during each iterative masked inpainting step such that the size of the mask 935 is gradually reduced over the course of the time-domain instances (e.g., from t=1 to t=max). The resulting denoised image is largely devoid of noise and includes latent values representing “Tim.” The combination of dynamic mask modification and blended masked-maskless inpainting serves to mitigate rigid boundary addition during the denoising process such that the denoised image is largely devoid color inconsistencies.

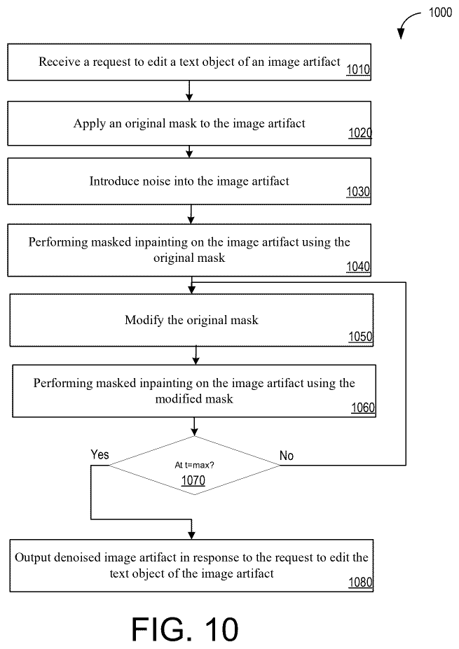

FIG. 10 is a flowchart of a method 1000 for dynamic mask modification. At step 1010, the method includes receiving a request to edit a text object of an image artifact. At step 1020, an original mask is applied to the image artifact for editing the text object of the image artifact. The original mask delineates a border between a masked region of the image artifact and an unmasked region of the image artifact. At step 1030, noise is introduced into the image artifact such that the noise spans the masked region and at least a portion of the unmasked region. At step 1040, masked inpainting is performed on the image artifact during an initial time-domain instance using the original mask to partially remove the noise from the image artifact. At step 1050, the original mask is modified. At step 1060, masked inpainting is performed on the image artifact during a subsequent time-domain instance using the modified mask. The method 1000 then proceeds to step 1070, where it is determined whether the current time-domain instance is t=max. If so, then iterative inpainting is complete and the method 1000 proceeds to step 1080. Otherwise, the method 1000 reverts back to step 1050. At step 1080, a denoised image artifact that includes an edited text object is output in response to the request to edit the text object of the image artifact. The modified mask may delineate a different border between the masked region and the unmasked region than the original mask. Modifying the original mask after the initial time-domain instance may include reducing a size of the masked region, increasing a size of the masked region, or modifying a shape of the masked region. In some examples, maskless inpainting is performed on the image artifact during an intermediate time-domain instance in-between the initial time-domain instance and the subsequent time-domain instance. The original mask may be removed from the image artifact in-between the initial time-domain instance and the intermediate time-domain instance. The modified mask may be re-applied to the image artifact in-between the intermediate time-domain instance and the subsequent time-domain instance.

In some examples, smoothing may be applied after each iteration of masked inpainting. For example, smoothing may include averaging neighboring masked and unmasked latent values along the original border delineated by the original mask during the initial time-domain instance, and averaging neighboring masked and unmasked latent values along a modified border delineated by the modified mask during the subsequent time-domain instance.

Embodiments of this disclosure provide mask boundary latent value smoothing techniques to augment dynamic mask modification for the purpose of further mitigating color inconsistencies. More specifically, mask boundary latent value smoothing serves to smooth latent values at the border of the masked region after each iteration of masked inpainting. This smoothing serves to at least partially normalize masked and unmasked latent values along the masked region border as the mask size is gradually decreased over the iterative denoising process.

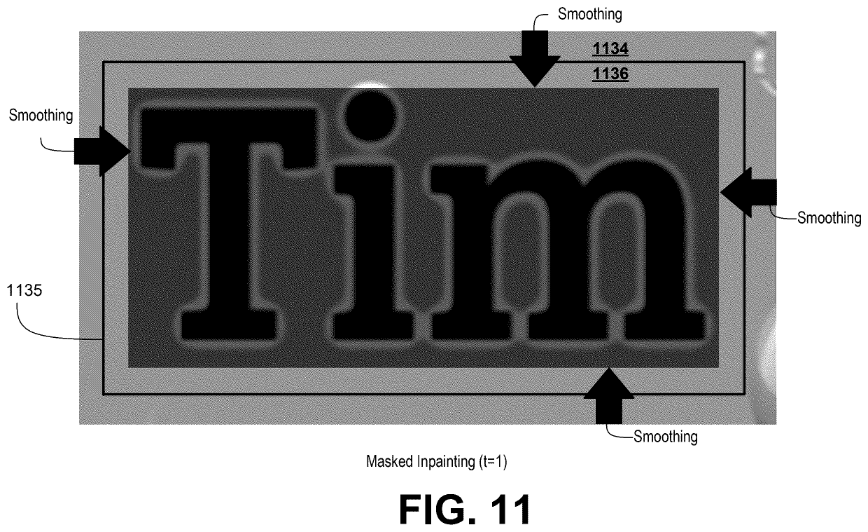

FIG. 11 is a diagram of mask boundary latent value used during masked inpainting. As shown, latent value smoothing is performed along the border of the mask 1135 such that masked latent values at the border of the masked region are averaged with neighboring masked and unmasked latent values. This eliminates, or otherwise materially mitigates, abrupt changes in latent values at the border of the masked region. It should be appreciated that masked latent values 1136 are averaged with their K closest neighboring latent values (K being an integer greater than or equal to one), where K is a predetermined number of closest neighboring latent values. The K closest neighboring latent values include at least one neighboring unmasked latent value 1134. In some examples, K closest neighboring latent values consists of neighboring unmasked latent values 1134. In other examples, the K closest neighboring latent values include both neighboring unmasked latent values 1134 and neighboring masked latent values 1136 such that the magnitude of each of the neighboring unmasked latent values 1134 is an average of both neighboring masked and unmasked latent values. It should be further appreciated that the latent value of unmasked latent values remains unmodified until completion of the iterative inpainting.

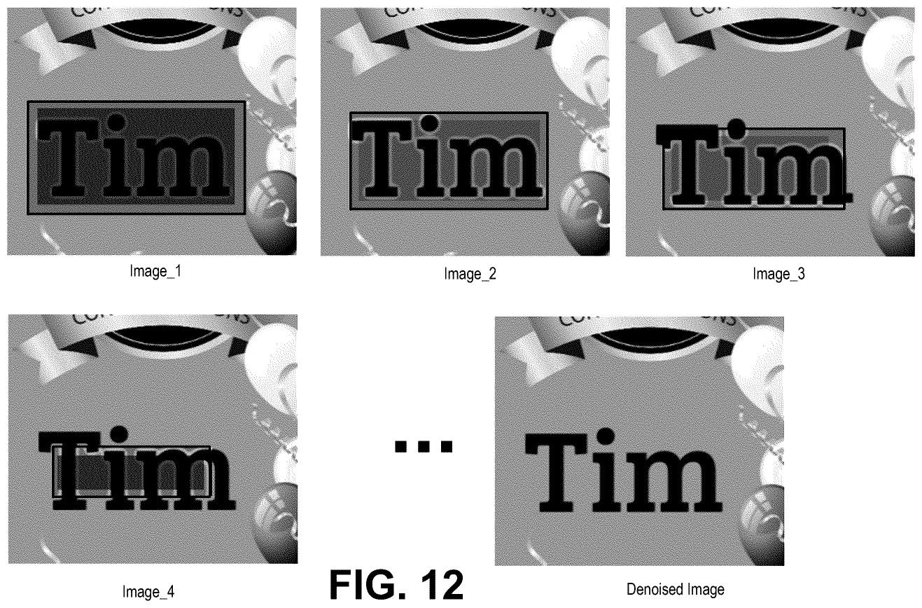

FIG. 12 is a diagram of mask boundary latent value smoothing used in conjunction with dynamic mask modification during masked inpainting. In this example, mask boundary latent value smoothing is performed in conjunction with dynamic mask modification to further limit color inconsistencies resulting from masked inpainting. As shown, smoothing is performed along masked latent values positioned along the border of the masked region after each successive masked inpainting stage. That is, after masked inpainting is performed iteratively at each time-domain instance (e.g., t=1, t=2, t=3, t=4, etc.), an additional latent value smoothing step is performed to average masked latent values at the border of the masked region with their K closest neighboring masked and unmasked latent values. This smoothing serves to further mitigate abrupt changes in latent values within the masked region, thereby further reducing color consistency.

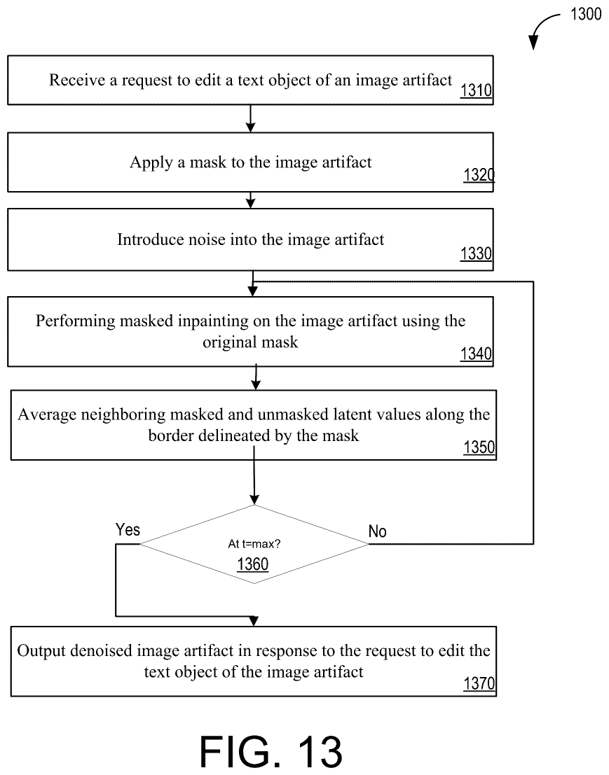

FIG. 13 is a flowchart of a method 1300 for mask boundary latent value smoothing. At step 1310, the method includes receiving a request to edit a text object of an image artifact. At step 1320, mask is applied to the image artifact for editing the text object of the image artifact. The mask delineates a border between a masked region of the image artifact and an unmasked region of the image artifact. At step 1330, noise is introduced into the image artifact such that the noise spans the masked region and at least a portion of the unmasked region. At step 1340, masked inpainting is performed on the image artifact using the mask to partially remove the noise from the image artifact. At step 1350, smoothing is performed by averaging neighboring masked and unmasked latent values along the border delineated by the mask. The method 1300 then proceeds to step 1360, where it is determined whether the current time-domain instance is t=max. If so, then iterative inpainting is complete and the method 1300 proceeds to step 1370. Otherwise, the method 1300 reverts back to step 1340. At step 1370, a denoised image artifact that includes an edited text object is output in response to the request to edit the text object of the image artifact. In some embodiments, averaging the neighboring masked and unmasked latent values along the border includes identifying a masked latent value positioned along the border and modifying a magnitude of the masked latent value based on an average of the masked latent value and a predetermined number of closest neighboring latent values. The closest neighboring latent values include at one neighboring unmasked latent value that neighbors the masked latent value. It should be appreciated that the modified masked latent value may be averaged exclusively with neighboring unmasked latent values. Alternatively, the modified masked latent value may be averaged with a combination of neighboring unmasked latent value(s) and neighboring masked latent value(s). It should further be appreciated that magnitudes of the neighboring unmasked latent values may not be modified during the smoothing operation, and that the term “averaging” refers to a mathematical process for calculating new magnitudes of the masked latent value(s) that are being modified during the corresponding operation. It should further be appreciated that the “average” may be a weighted or unweighted average. For instance, different weights may be applied to different latent values based on a classification (e.g., masked vs unmasked) and/or a relative proximity to the masked latent value being modified. Alternatively, a simple average of all neighboring latent values may be used to update the magnitude of the masked latent value being modified.

Embodiment techniques described herein may be effective across all SDXL inpainting pipeline-based artifacts and may be generalized to Flux inpainting and other pipelines.

### Exemplary Operating Environment

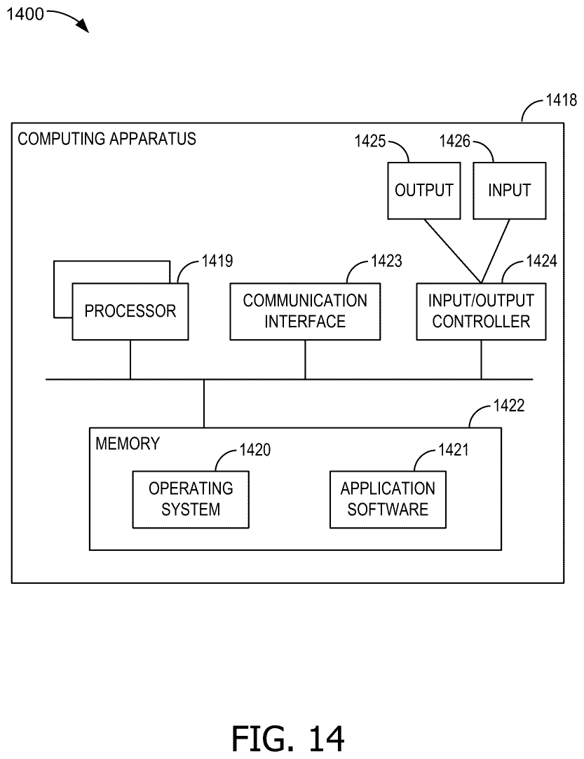

The present disclosure is operable with a computing apparatus according to an embodiment as a functional block diagram 1400 in FIG. 14. In an example, components of a computing apparatus 1418 are implemented as a part of an electronic device according to one or more embodiments described in this specification.

The computing apparatus 1418 comprises one or more processors 1419 which can be microprocessors, controllers, or any other suitable type of processors for processing computer executable instructions to control the operation of the electronic device. Alternatively, or in addition, the processor 1419 is any technology capable of executing logic or instructions, such as a hardcoded machine. In some examples, platform software comprising an operating system 1420 or any other suitable platform software is provided on the apparatus 1418 to enable application software 1421 to be executed on the device.

In some examples, computer executable instructions are provided using any computer-readable medium or media accessible by the computing apparatus 1418. Computer-readable media include, for example, computer storage media such as a memory 1422 and communications media. Computer storage media, such as a memory 1422, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium does not include a propagating signal. Propagated signals per se are not examples of computer storage media. Although the computer storage medium (the memory 1422) is shown within the computing apparatus 1418, it will be appreciated by a person skilled in the art, that, in some examples, the storage is distributed or located remotely and accessed via a network or other communication link (e.g., using a communication interface 1423).

Further, in some examples, the computing apparatus 1418 comprises an input/output controller 1424 configured to output information to one or more output devices 1425, for example a display or a speaker, which are separate from or integral to the electronic device. Additionally, or alternatively, the input/output controller 1424 is configured to receive and process an input from one or more input devices 1426, for example, a keyboard, a microphone, or a touchpad. In one example, the output device 1425 also acts as the input device. An example of such a device is a touch sensitive display. The input/output controller 1424 in other examples outputs data to devices other than the output device, e.g., a locally connected printing device. In some examples, a user provides input to the input device(s) 1426 and/or receives output from the output devices 1425.

The functionality described herein can be performed, at least in part, by one or more hardware logic components. The computing apparatus 1418 is configured by the program code when executed by the processor 1419 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

Any range or device value given herein may be extended or altered without losing the effect sought, as will be apparent to the skilled person.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent can take the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute exemplary means for receiving a first search request, the first search request including one or more search terms; identifying one or more product categories as output from a machine learning classification model in response to inputting of the one or more search terms; identifying a first plurality of products that are assigned to the one or more product categories, each product of the first plurality of products including a plurality of product titles and a plurality of product short descriptions in a natural language; applying the plurality of product titles and the plurality of product short descriptions as input to a second machine learning model that is configured to generate a plurality of recommended searches, each recommended search of the plurality of recommended searches including at least one search term; scoring each recommended search of the plurality of recommended searches; selecting one or more recommended searches of the plurality of recommended searches based on the scoring; and causing the one or more recommended searches to be displayed as user-interactable components on a graphical user interface, each user-interactable component being configured to execute a second search request upon user interaction with the user-interactable component.

At least a portion of the functionality of the various elements in FIG. 1 to FIG. 9 can be performed by other elements.

In some examples, the operations described herein can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Within the scope of this application, it is expressly intended that the various aspects, embodiments, examples, and alternatives set out in the preceding paragraphs, in the claims and/or in the description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim, accordingly, including the right to amend any originally filed claim to depend from and/or incorporate any feature of any other claim although not originally claimed in that manner.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method for blended masked-maskless inpainting, the method comprising:
receiving a request to edit a text object of an image artifact;
applying, to the image artifact, a mask for editing the text object of the image artifact, the mask delineating a border between a masked region of the image artifact and an unmasked region of the image artifact;
introducing, into the image artifact, noise spanning the masked region and at least a portion of the unmasked region;
performing iterative inpainting on the image artifact over a sequence of time-domain instances to obtain a denoised image artifact that includes an edited text object, wherein performing iterative inpainting on the image artifact includes performing masked inpainting on the image artifact during an initial time-domain instance and performing maskless inpainting to at least partially remove residual noise from the image artifact during a subsequent time-domain instance, the mask being removed from the image artifact in between the initial time-domain instance and the subsequent time-domain instance; and
outputting the denoised image artifact in response to the request to edit the text object of the image artifact.

2. The method of claim 1, wherein performing masked inpainting introduces, into the masked region, latent values for forming the edited text object.

3. The method of claim 2, wherein the maskless inpainting at least partially removes the residual noise from the image artifact without impacting the latent values forming the image artifact.

4. The method of claim 1, wherein performing iterative inpainting on the image artifact comprises performing the masked inpainting on the image artifact during a first subset of the time-domain instances and performing the maskless inpainting on the image artifact during a second subset of the time-domain instances.

5. The method of claim 4, wherein the first subset of time-domain instances are interleaved with the second subset of time-domain instances such that the masked inpainting and the maskless inpainting are performed in an alternating fashion.

6. The method of claim 4, wherein the first subset of time-domain instances include at least twice as many time-domain instances as the second subset of time-domain instances such that the masked inpainting is performed at least twice as often as the maskless inpainting.

7. The method of claim 4, further comprising allocating the first subset of the time-domain instances to the masked inpainting based on a hyperparameter defining a ratio or number of masked inpainting iterations relative to maskless inpainting iterations.

8. A method for dynamic mask modification, the method comprising:
receiving a request to edit a text object of an image artifact;
applying, to the image artifact, an original mask for editing the text object of the image artifact, the original mask delineating an original border between a masked region of the image artifact and an unmasked region of the image artifact;
introducing, into the image artifact, noise spanning the masked region and at least a portion of the unmasked region;
performing iterative inpainting on the image artifact over a sequence of time-domain instances to obtain a denoised image artifact that includes an edited text object, wherein performing iterative inpainting on the image artifact includes performing masked inpainting on the image artifact during an initial time-domain instance using the original mask, modifying the original mask after the initial time-domain instance, and performing masked inpainting on the image artifact during a subsequent time-domain instance using the modified mask; and
outputting the denoised image artifact in response to the request to edit the text object of the image artifact.

9. The method of claim 8, wherein the modified mask delineates a different border between the masked region and the unmasked region than the original mask.

10. The method of claim 8, wherein modifying the original mask after the initial time-domain instance includes reducing a size of the masked region.

11. The method of claim 8, wherein modifying the original mask after the initial time-domain instance includes increasing a size of the masked region.

12. The method of claim 8, wherein modifying the original mask after the initial time-domain instance includes modifying a shape of the masked region.

13. The method of claim 8, wherein performing iterative inpainting on the image artifact further includes performing maskless inpainting on the image artifact during an intermediate time-domain instance in-between the initial time-domain instance and the subsequent time-domain instance.

14. The method of claim 13, wherein the original mask is removed from the image artifact in-between the initial time-domain instance and the intermediate time-domain instance, and wherein the modified mask is re-applied to the image artifact in between the intermediate time-domain instance and the subsequent time-domain instance.

15. The method of claim 7, performing iterative inpainting further comprises:
averaging, during the initial time-domain instance, neighboring masked and unmasked latent values along the original border delineated by the original mask; and
averaging, during the subsequent time-domain instance, neighboring masked and unmasked latent values along a modified border delineated by the modified mask.

16. A method for mask boundary latent value smoothing, the method comprising:
receiving a request to edit a text object of an image artifact;
applying, to the image artifact, a mask for editing the text object of the image artifact, the mask delineating a border between a masked region of the image artifact and an unmasked region of the image artifact;
introducing, into the image artifact, noise spanning the masked region and at least a portion of the unmasked region;
performing iterative inpainting on the image artifact to obtain a denoised image artifact that includes an edited text object, wherein performing iterative inpainting on the image artifact includes performing masked inpainting on the image using the mask and averaging neighboring masked and unmasked latent values along the border delineated by the mask; and
outputting the denoised image artifact in response to the request to edit the text object of the image artifact.

17. The method of claim 16, wherein averaging the neighboring masked and unmasked latent values along the border delineated by the mask comprises:
identifying a masked latent value positioned along the border delineated by the mask; and
modifying a magnitude of the masked latent value based on an average of the masked latent value and a predetermined number of closest neighboring latent values, wherein the closest neighboring latent values include at least one neighboring unmasked latent value that neighbors the masked latent value.

18. The method of claim 17, wherein the closest neighboring latent values further include at least one neighboring masked latent value that neighbors the masked latent value.

19. The method of claim 17, wherein the closest neighboring latent values consist of neighboring unmasked latent values that neighbor the masked latent value.

20. The method of claim 17, wherein a magnitude of the at least one neighboring unmasked latent value remains unmodified until completion of the iterative inpainting.
